(19) United States
(12) Patent Application Publication
(10) Pub. No.: US 2026/0244010 A1
(43) Pub. Date: Aug. 20, 2026

(54) System and Method for Parallelized 3D Measurement of Multicellular Specimens

(71) Applicant: Ramona Optics, Inc., Durham, NC (US)

(72) Inventors: Paul Reamey, Durham, NC (US); Natalie Sutton Alvarez, Durham, NC (US); Gregor John Horstmeyer, Durham, NC (US); Mark Harfouche, Durham, NC (US); Aurélien Gauthier Florent Bègue, Durham, NC (US)

(21) Appl. No.: 19/054,783

(22) Filed: Feb. 15, 2025

(51) Int. Cl. G02B 21/00; G01N 21/64; G02B 21/12

(52) U.S. Cl. CPC G02B 21/008; G01N 21/6428; G02B 21/0032; G02B 21/0036; G02B 21/0076; G02B 21/12; G01N 2021/6439

(57) ABSTRACT

Disclosed is a system for imaging multi-well plates. The system comprises a micro-camera array, an illumination array, a scanning mechanism, a controller and a processor. The scanning mechanism moves the micro-camera and illumination arrays in three dimensions relative to the multi-well plate. The controller positions the arrays, activates illumination and captures image data. The processor generates 3D (three-dimensional) measurements of specimens within wells. The processor maps image data to per-specimen 3D measurements, generates statistical data and tracks specimens longitudinally. The system provides even illumination across wells using optimized optical elements and a polymer-dispersed liquid crystal sheet. Thus, the system enables rapid 3D imaging and analysis of specimens across high-density well plates, allowing high-throughput 3D imaging and analysis of multicellular specimens.

### FIELD OF THE INVENTION

The present disclosure relates generally to microscopy and imaging technology and particularly, to a high-throughput three-dimensional imaging system for efficient scanning and imaging of multi-well plates containing biological specimens such as organoids.

### BACKGROUND OF THE INVENTION

In vitro organoids have emerged as valuable tools for studying complex biological systems, offering insights into tissue development, disease modeling and drug screening. The three-dimensional cellular structures associated with in vitro organoids mimic architecture and functionality of organs, providing researchers with a more physiologically relevant platform compared to traditional two-dimensional cell cultures. Further, the organoids can be derived from various tissues, including brain, liver, kidney and intestine, allowing investigation of organ-specific processes and pathologies. The ability to generate patient-derived organoids has provided new avenues for personalized medicine and testing of therapeutic interventions on patient-specific tissue models. Moreover, organoids have found applications in developmental biology, toxicology studies and regenerative medicine, offering a bridge between in vitro experiments and in vivo models.

However, efficient imaging of in vitro organoids still remains challenging. For example, standard scanning microscopes typically require tens of minutes to over one hour of hands-on time to step-and-scan through an entire plate. Such a prolonged imaging process poses significant challenges for researchers studying organoid development and behavior. It will be appreciated that the extended time required for imaging can disrupt the delicate microenvironment of the organoids, potentially altering growth patterns and cellular interactions thereof. Moreover, the manual intervention required during the scanning process introduces variability and increases a risk of human error. Such limitations hinder an ability to capture dynamic processes and transient events within the organoids, potentially missing critical information about development and responses thereof to external stimuli.

Additionally, increased time outside the controlled environment of a tissue culture incubator can adversely affect survival of the organoids. For example, the exposure of the organoids to suboptimal conditions during lengthy imaging sessions can lead to cellular stress, altered gene expression and even cell death. Thus, such exposure is associated with challenges for long-term studies and experiments involving sensitive organoid models. The disruption of the carefully maintained incubator conditions such as temperature, humidity and gas composition can introduce confounding variables into the experimental setup. Furthermore, the extended imaging time limits the throughput of experiments, reducing the number of samples that can be analyzed within a given timeframe and potentially impacting the statistical power of studies involving the organoids.

Accordingly, high-content microscopes have recently been developed to address some of the aforesaid challenges. For example, companies such as Molecular Devices, Thermo Fisher Scientific and Nikon have designed microscopes to scan and image a full well plate in two dimensions in several minutes. Such advanced microscopes utilize automated stage movement and rapid image acquisition techniques to significantly reduce the time required for scanning large sample areas. Further, a high-content imaging approach utilized by such microscopes allows for simultaneous measurement of multiple cellular parameters, enabling more comprehensive analysis of organoid morphology and function. However, such systems typically require up to one hour for image capture if axial scanning is required to obtain 3D (three-dimensional) information. The aforesaid limitation arises from a need to capture multiple focal planes to reconstruct the 3D structure of organoids that is crucial for accurately assessing complex architecture and cellular organization thereof.

Moreover, traditional methods for organoid imaging have relied on confocal microscopy to provide high-resolution 3D images. However, confocal microscopy is often time-consuming and may cause photodamage to the samples due to repeated laser exposure. Further, light-sheet microscopy has emerged as an alternative, offering faster acquisition speeds and reduced phototoxicity. However, light-sheet microscopic systems often require specialized sample preparation and may not be suitable for high-throughput screening of multi-well plates. Additionally, other approaches such as optical coherence tomography and multiphoton microscopy have been explored for organoid imaging but face limitations in terms of throughput, resolution or compatibility with standard culture formats.

Further, a micro-camera array microscope (MCAM) system has been developed by Ramona Optics to address some of the challenges in high-content imaging (for example, U.S. Pat. Nos. 10,976,535B2 and 11,153,508B2 and United States patent applications US20210255448A1 and US20220179187A1). The MCAM consists of an array of closely spaced micro-cameras, such that each micro-camera is capable of imaging in parallel across a unique area of an object of interest. Further, other previous systems have considered arrays of imaging systems for microscopic image acquisition for parallelized acquisition of images from well plates (such as, U.S. Pat. Nos. 10,754,140B2 and 10,732,396B2).

However, the above systems are associated with a number of limitations. Firstly, existing multi-camera systems for well plate imaging cannot scale to high-density well plate formats due to a requirement that one micro-camera per well is required to view all the wells. Secondly, existing systems are not optimized to deliver even specimen illumination within deep wells, which is critical for next-generation multicellular specimen development and high-throughput study (such as, for organoid-type specimens). Thirdly, existing systems are not optimized for 3D image acquisition and the generation of accurate key metrics of multicellular systems (such as, surface area, volume, morphological features and fluorescent bioactivity).

Accordingly, there is an urgent need to overcome the various limitations of available systems with respect to 3D imaging across high-density well plates.

### SUMMARY OF THE INVENTION

The present disclosure provides a 3D (three-dimensional) array and illumination scanning system and method that employs a camera array to jointly scan an entire well plate while also scanning illumination levels to ensure effective imaging performance.

In one aspect, a system for imaging multi-well plates is provided. The system comprises a micro-camera array comprising a plurality of micro-cameras, an illumination source configured to provide illumination to the wells of the multi-well plate and a scanning mechanism coupled to the micro-camera array and the illumination array. The scanning mechanism is configured to move the micro-camera array and the illumination source in three dimensions relative to the multi-well plate. Further, the system comprises a controller configured to control the scanning mechanism to position the micro-camera array and the illumination source relative to the multi-well plate, activate the illumination source to illuminate wells of the multi-well plate and control the micro-camera array to capture image data of the illuminated wells. Moreover, the system comprises a processor configured to process the captured image data to generate 3D measurements of the specimens within the wells.

In one embodiment, the illumination source comprises a plurality of light sources arranged to provide even illumination across the wells of the multi-well plate.

In another embodiment, the illumination source comprises one or more optical elements configured to optimize the illumination provided by the light sources.

In yet another embodiment, the system further comprises a polymer-dispersed liquid crystal (PDLC) sheet configured to enhance evenness and brightness of illumination.

In still another embodiment, the illumination source is configured to provide both bright-field and fluorescent illumination.

In a further embodiment, the scanning mechanism is configured to move the micro-camera array and the illumination source without disturbing the multi-well plate.

In another embodiment, the processor is further configured to map the captured image data into per-specimen 3D measurements and generate statistical data associated with the 3D measurements.

In yet another embodiment, the processor is further configured to track the per-specimen measurements longitudinally across multiple imaging sessions.

In still another embodiment, the processor is configured to process the captured image data to generate one or more of volume measurements, surface area measurements, density measurements and surface granularity measurements of the specimens.

In a further embodiment, the processor is configured to process the captured image data within 45 seconds for a full-plate focal stack.

In another embodiment, the system further comprises a user interface configured to display computed metrics and provide access to fitted surface manifolds and aligned focal stacks.

In yet another embodiment, the processor is further configured to process fluorescence image data to monitor calcium activity and diffusion processes of fluorescent dyes into multi-cellular bodies.

In still another embodiment, the processor is further configured to locate individual cells within the specimens, measure total fluorescence per-channel within each cell and aggregate average and total fluorescence across cells.

In a further embodiment, the processor is further configured to track individual cells longitudinally to measure per-cell fluorescence brightness variations.

In another embodiment, the processor is further configured to compute one or more of minimum, mean and maximum projections of the acquired fluorescence intensity data along an axial dimension.

In another aspect, a method for imaging multi-well plates is provided. The method comprises positioning a micro-camera array and an illumination source relative to a multi-well plate using a scanning mechanism, activating the illumination source to illuminate wells of the multi-well plate, capturing image data of the illuminated wells using the micro-camera array, processing the captured image data to generate 3D (three-dimensional) measurements of specimens within the wells and moving the micro-camera array and the illumination source in three dimensions relative to the multi-well plate using the scanning mechanism to image multiple wells.

In an embodiment, the method further comprises mapping the captured image data into per-specimen 3D measurements and generating statistical data associated with the 3D measurements.

In another embodiment, the method comprises tracking the per-specimen 3D measurements longitudinally across multiple imaging sessions.

In yet another embodiment, the processing further comprises processing the captured image data to generate one or more of volume measurements, surface area measurements, density measurements and surface granularity measurements of the specimens.

In still another embodiment, the processing further comprises processing fluorescence image data to monitor calcium activity and diffusion processes of fluorescent dyes into multi-cellular bodies. Such processing further comprises locating individual cells within the specimens, measuring total fluorescence per-channel within each cell and aggregating average and total fluorescence across cells.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

Having thus described the subject matter of the present invention in general terms, reference will now be made to the accompanying drawings, which are not necessarily drawn to scale, and wherein:

FIG. 1 illustrates a front view of a multi-camera array microscope, in accordance with an embodiment of the present disclosure

FIG. 2 illustrates a schematic illustration of the system for imaging multi-well plates, in accordance with an embodiment of the present disclosure;

FIG. 3 illustrates a schematic illustration of a focal stack information acquisition method performed using the system of FIG. 2, in accordance with an embodiment of the present disclosure;

FIGS. 4A-B illustrates a joint scanning apparatus in two lateral positions, in accordance with embodiments of the present disclosure;

FIG. 5 illustrates a workflow for image processing and analysis, in accordance with an embodiment of the present disclosure;

FIGS. 6A-B illustrate different stages of an illumination and scanning method, in accordance with an embodiment of the present disclosure;

FIG. 7 illustrates an exploded view of the overall architecture of a system (such as the system of FIG. 2) with three-dimensional scanning and analysis capabilities, in accordance with an embodiment of the present disclosure;

FIGS. 8A-D illustrates an exemplary image processing pipeline for organoid detection and analysis, in accordance with an embodiment of the present disclosure; and

FIG. 9 illustrates a method for parametric modeling and longitudinal tracking of three-dimensional organoid surface, in accordance with an embodiment of the present disclosure.

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As described more fully below, the present disclosure is directed to a 3D (three-dimensional) array and illumination scanning system and method. The system and method employ a camera array to jointly scan an entire well plate while also scanning illumination levels to ensure effective imaging performance. The system comprises an optically optimized illumination source to provide even excitation and specialized film to maximize evenness and brightness of bright-field illumination and to obtain very high-speed capture in high-density plates. The system and method are optimized to generate accurate key metrics of multicellular systems. The system and method are further tailored for use in a parallelized microscope for rapid imaging and analysis of many specimens.

An advantage of the present disclosure is that the system enables high-throughput 3D imaging of multi-well plates containing biological specimens such as organoids.

Another advantage of the present disclosure is that the system and method enable efficient scanning and even illumination across high-density multi-well plate formats for both bright-field and fluorescent imaging.

Yet another advantage of the present disclosure is that the system and method enable to generate accurate 3D measurements and statistical data of multicellular specimens within wells through optimized image acquisition and processing.

Still another advantage of the present disclosure is that the system and method allow longitudinal tracking and analysis of 3D morphological and functional changes in specimens across multiple imaging sessions.

Accordingly, the present disclosure provides a powerful system and method for high-throughput 3D imaging and analysis of biological specimens in multi-well plates.

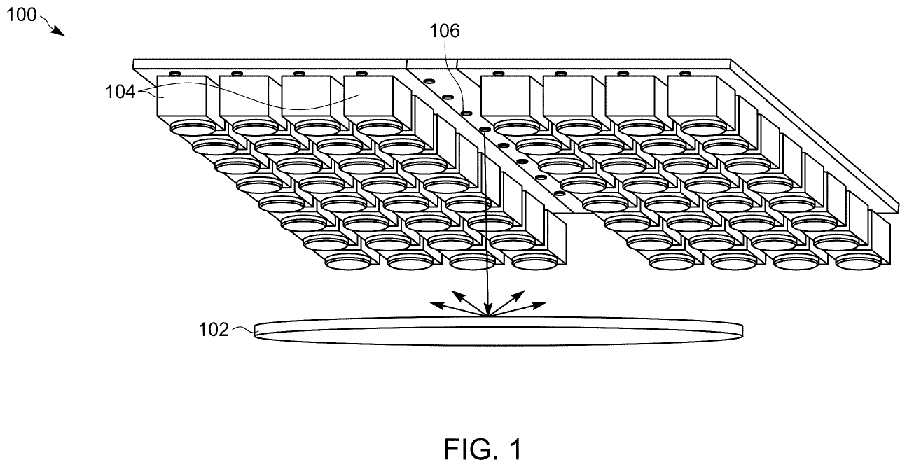

Referring to FIG. 1, there is illustrated a front view of a multi-camera array microscope 100, in accordance with an embodiment of the present disclosure. The multi-camera array microscope 100 is designed to enable effective imaging across high-density multi-well plates. The multi-camera array microscope 100 comprises an imaging plane 102 and a plurality of illumination sources 104. The imaging plane 102 is an area where the specimen is placed for observation and imaging and enables capturing the images of the specimen. The imaging plane 102 is designed to enable capture high-resolution images of the specimen, which can be a biological sample, a chemical compound or any other object of interest. The imaging plane 102 works in conjunction with the illumination sources 104 to produce clear, detailed images of the specimen.

The illumination sources 104 provide the necessary light for the imaging process. The illumination sources 104 are strategically positioned above the imaging plane 102 to provide even and optimal illumination for imaging the specimen. The illumination sources 104 can be implemented as light-emitting diode (LED) lights, halogen lamps or any other suitable light sources. The illumination sources 104 are designed to provide a uniform and consistent light distribution across the entire imaging plane 102. Such an operation of the illumination sources 104 ensures that all the parts of the specimen are equally illuminated, thereby enabling the capture of high-quality and evenly lit images.

The multi-camera array microscope 100 further comprises a specimen radiation unit 106. The specimen radiation unit 106 is designed to emit radiation onto the specimen placed on the imaging plane 102. The emitted radiation interacts with the specimen, causing the specimen to emit or scatter radiation. Such an interaction between the emitted radiation and the specimen provides valuable information about the specimen, such as structure, composition and other properties thereof.

The multi-camera array microscope 100 provides a flexible and versatile platform for imaging a wide variety of specimens. The multi-camera array microscope 100 is associated with a unique design that comprises the imaging plane 102, the plurality of illumination sources 104 and the specimen radiation unit 106, thereby allowing the multi-camera array microscope 100 to allow capturing of high-quality images under a wide range of lighting and radiation conditions. Such an operation of the multi-camera array microscope 100 makes the multi-camera array microscope 100 an invaluable tool for researchers and scientists in various fields such as biology, chemistry and materials science.

In one embodiment, the multi-camera array microscope 100 can be equipped with a high-resolution digital camera for capturing detailed images of the specimen. The digital camera can be equipped with a high-quality lens for capturing sharp and clear images. The digital camera can also be equipped with advanced imaging features such as zoom, focus and image stabilization to enhance the quality of the captured images.

In another embodiment, the illumination sources 104 can be adjustable, allowing the user to control the intensity and direction of the illumination. Such a feature can be particularly useful in situations where the specimen requires specific lighting conditions for optimal imaging. The adjustable illumination sources 104 can also be programmable, allowing the user to set pre-defined lighting patterns for different types of specimens.

In yet another embodiment, the specimen radiation unit 106 can be designed to emit different types of radiation, such as ultraviolet, infrared or X-ray radiation. Such an operation can be useful for imaging specimens that interact differently with different types of radiation. The specimen radiation unit 106 can also be adjustable, allowing the user to control the intensity and wavelength of the emitted radiation.

In a further embodiment, the multi-camera array microscope 100 comprises a user interface for controlling the operation of the multi-camera array microscope 100. The user interface can include controls for adjusting the imaging plane 102, the illumination sources 104 and the specimen radiation unit 106. The user interface can also include a display for viewing the captured images and a storage unit for storing the captured images.

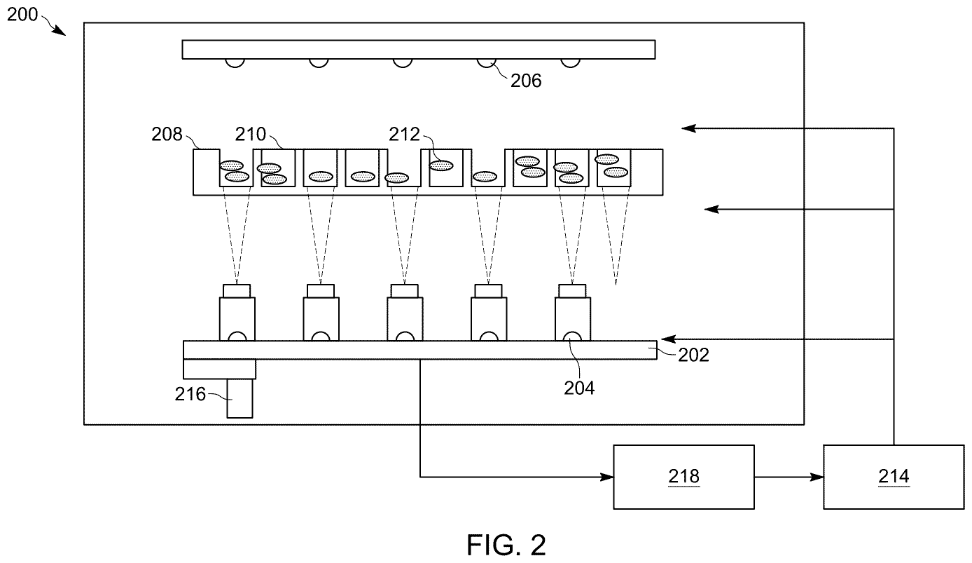

Referring to FIG. 2, there is illustrated a schematic illustration of the system 200 for imaging multi-well plates 210, in accordance with an embodiment of the present disclosure. The system 200 comprises an imaging array 202 (alternatively referred to as a “micro-camera array”), optical elements 204, at least one illumination source 206 (also referred to as a “illumination array”), a specimen plane 208, at least one well plate 210 (also referred to as a “multi-well plate), a specimen 212, a computer processing and control unit 214 (alternatively referred to as a “controller”), a z-axis actuator 216 and a processor 218. The system 200 facilitates high-throughput, high-resolution imaging of specimens 212.

The imaging array 202 is a key component of the system 200 and is designed to capture high-resolution images of the specimen 212. The imaging array 202 is equipped with multiple sensors to capture detailed and accurate images. The multiple sensors are implemented as multiple small cameras arranged in a specific configuration. Such an imaging array 202 allows simultaneous imaging of multiple wells in the multi-well plate 210, significantly increasing the throughput of the imaging process. The micro-cameras are designed to capture high-resolution images of specimens within the wells, enabling detailed analysis of morphology and behavior of the specimen 212 contained therein. The imaging array 202 can be customized in terms of camera number, spacing and arrangement to accommodate different well plate formats and experimental requirements. The micro-camera array 202 offers advantages such as increased imaging speed, reduced mechanical complexity and an ability to simultaneously capture multiple focal planes. The preparation of the micro-camera array 202 involves careful selection and integration of individual cameras, precise alignment and calibration to ensure uniform imaging performance across the array. Further, different types of micro-cameras can be used in the imaging array 202, including but not limited to, complementary metal-oxide-semiconductor (CMOS) sensors, charge-coupled device (CCD) sensors, high-speed cameras, fluorescence-optimized cameras and multispectral imaging cameras. Further, examples of micro-camera configurations include linear arrays, two-dimensional (2D) arrays, staggered arrays and modular arrays that can be customized for different well plate formats.

The imaging array 202 is designed to work in conjunction with the optical elements 204, which are responsible for focusing and directing the light towards the specimen 212. The optical elements 204 can comprise lenses, mirrors and other optical components that manipulate light to ensure optimal imaging conditions.

The illumination source 206 is another crucial component of the system 200 and provides the necessary light for imaging the specimen 212. The illumination source 206 can be designed to produce light of varying intensities and wavelengths, depending on the requirements of the imaging process. In an embodiment, the illumination source 206 comprises a plurality of light sources arranged to provide even illumination across the wells of the multi-well plate 210. Such an arrangement of the plurality of light sources ensures uniform lighting conditions for all specimens 212, which is crucial for accurate and comparable imaging results. The light sources are carefully positioned and calibrated to minimize shadows and reflections, creating optimal conditions for both bright-field (BF) and fluorescence imaging. The illumination source 206 can be implemented as an array comprising different types of light sources, such as white LEDs for bright-field imaging and specific wavelength LEDs or lasers for fluorescence excitation. The even illumination provided by the illumination source 206 implemented as the array enhances image quality, reduces artifacts and improves the reliability of quantitative measurements. Further, preparation of the illumination source 206 comprises precise placement of light sources, integration of diffusers or other optical elements to enhance uniformity, and implementation of control systems for adjusting illumination parameters. Moreover, types of light source arrangements include matrix configurations, concentric ring layouts and adaptive illumination patterns. Additionally, examples of illumination strategies include sequential activation of different light sources for multi-modal imaging, pulsed illumination for reducing phototoxicity and spatially structured illumination for enhanced resolution.

In another embodiment, the illumination source 206 further comprises one or more optical elements configured to optimize the illumination provided by the light sources. The optical elements are designed to shape, direct and homogenize the light output from the light sources. The optical elements may include collimating lenses to create parallel light beams, diffusers to spread light evenly and filters to select specific wavelengths for fluorescence excitation. The optical elements enhance the quality and efficiency of illumination, improving image contrast and reducing unwanted artifacts. Further, key properties of the optical elements include high transmission efficiency, minimal aberrations and compatibility with a wide range of wavelengths. The incorporation of the optical elements offers advantages such as improved light utilization, reduced background noise and the ability to create specialized illumination patterns. Additionally, preparation of the optical elements involves careful selection of materials, precision manufacturing processes and integration with the light source array. Moreover, types of optical elements that can be employed within the illumination source 206 include aspheric lenses, holographic diffusers, dichroic filters and liquid crystal tunable filters. Also, examples of optical configurations include Köhler illumination setups, light shaping diffusers and beam homogenizers.

In a separate embodiment, the system 200 for imaging multi-well plates 210 further comprises a polymer-dispersed liquid crystal (PDLC) sheet configured to enhance evenness and brightness of illumination. The PDLC technology allows for dynamic control of light transmission and scattering properties. The PDLC sheet consists of liquid crystal droplets dispersed in a polymer matrix, which can be electrically switched between transparent and scattering states. Such technology enables adaptive illumination control, allowing optimization of lighting conditions for different specimen types and imaging modes. Further, key properties of the PDLC sheet include fast switching times, uniform optical properties across the sheet and the ability to operate over a wide range of wavelengths. The PDLC sheet offers advantages such as on-demand adjustment of illumination intensity and distribution, reduction of glare and reflections and the ability to create structured illumination patterns. Moreover, preparation of the PDLC sheet involves precise control of liquid crystal droplet size and distribution, optimization of polymer matrix properties and integration of transparent electrodes for electrical control. Also, types of PDLC configurations include single-layer sheets, multi-layer stacks for enhanced control and patterned PDLC structures for spatially varying illumination. Additionally, examples of PDLC applications in the imaging system 200 include adaptive background illumination, contrast enhancement for specific specimen features and creation of oblique illumination for improved visibility of surface structures.

In yet another embodiment, the illumination source 206 is configured to provide both BF (diffuse) and fluorescent (non-diffuse) illumination, enabling multi-modal imaging capabilities within a single system. Such a dual-mode illumination allows for comprehensive analysis of specimens, combining structural information from BF imaging with specific molecular or functional insights from fluorescence imaging. The BF illumination component typically uses white light sources and is optimized for even illumination across the entire field of view. The fluorescence illumination component incorporates specific excitation wavelengths matched to common fluorophores used in biological research. Further, key properties of the dual-mode illumination system include rapid switching between the BF and fluorescence modes, spectral purity of excitation light and the ability to adjust illumination intensity independently for each mode. The combination of the BF and fluorescent illumination offers advantages such as correlative imaging of specimen structure and function, increased experimental flexibility and the ability to perform multi-parameter analysis on the same specimen. Additionally, preparation of the dual-mode illumination system involves integration of separate light sources or the use of multi-wavelength sources, incorporation of appropriate filters and dichroic mirrors and development of control systems for mode switching and intensity adjustment. Also, types of illumination configurations include LED-based systems with switchable wavelengths, laser-based systems with multiple laser lines and hybrid systems combining broadband and narrow-band sources. Moreover, examples of applications include simultaneous BF and fluorescence imaging for cell viability assays, sequential imaging for colocalization studies and alternating illumination for photoactivation experiments.

The specimen plane 208 is where the biological specimens or samples 212 is placed for imaging. The specimen plane 208 is designed to securely hold the specimen 212 in place during the imaging process. The specimen plane 208 may be a part of the multi-well plate 210 where each well contains a different biological specimen for high-throughput imaging. The specimen plane 208 is designed to be stable and precise, ensuring that the specimens remain in their designated positions during the imaging process.

The system 200 further comprises a controller 214 configured to control the scanning mechanism to position the micro-camera array 202 and the illumination source 206 relative to the multi-well plate 210, activate the illumination source 206 to illuminate wells of the multi-well plate 210 and control the micro-camera array 202 to capture image data of the illuminated wells. The controller 214 is responsible for controlling the operation of the imaging array 202, the optical elements 204 and the illumination source 206. The controller 214 is also responsible for processing the images captured by the imaging array 202. The controller 214 is a central component that orchestrates the operation of the entire system 200. The controller 214 is responsible for coordinating the movements of the scanning mechanism, activating the illumination array 206 and triggering image capture by the micro-camera array 202. The controller 214 operates based on predefined imaging protocols and can adapt to different experimental requirements. Further, key properties of the controller 214 comprise real-time processing capabilities, synchronization of multiple system components and the ability to handle high data throughput. The controller 214 offers advantages such as automated imaging sequences, integration of multiple imaging modalities and the ability to perform on-the-fly adjustments based on image quality feedback. Also, preparation of the controller 214 involves software development for user interface and system control, integration of hardware interfaces for various system components and implementation of data management and storage solutions. Additionally, types of controllers 214 include embedded systems, field programmable gate array (FPGA)-based controllers and distributed control systems. Also, examples of controller functionalities include automated focus adjustment, exposure optimization and intelligent scanning path determination based on well plate occupancy.

The z-axis actuator 216 is an integral part of the system 200 and is responsible for moving the imaging array 202 along the z-axis, which is perpendicular to the specimen plane 208. The z-axis actuator 216 can be a motorized stage or a similar mechanical device capable of precise movements. The z-axis actuator 216 is controlled by the computer processing and control unit 214 and is responsible for adjusting the focus of the imaging array 202 by moving the imaging array 202 along the z-axis. The z-axis actuator 216 allows the imaging array 202 to capture images at different depths of the specimen, enabling the formation of a 3D image of the specimen.

Moreover, the system 200 a processor 218 configured to process the captured image data to generate 3D measurements of specimens 212 within the wells. The processor 218 is a part of the controller 214 and is responsible for processing the images captured by the imaging array 202. The processor 218 uses advanced image processing algorithms to enhance the quality of the images and extract useful information from them. The processor 218 is a powerful computing unit designed to handle the large volumes of image data generated by the imaging array 202. The processor employs advanced image processing algorithms, including but not limited to, deconvolution, segmentation and 3D reconstruction techniques. Further, key properties of the processor 218 include high computational power, parallel processing capabilities and the ability to handle large datasets efficiently. The processor 218 offers advantages such as real-time image analysis, automated feature extraction and the ability to generate quantitative metrics for high-throughput screening applications. Moreover, preparation of the processor 218 involves selection of appropriate hardware (such as, multi-core central processing units (CPUs), graphics processing units (GPUs) and the like), implementation of optimized image processing algorithms and development of data analysis pipelines. Also, types of processors 218 include high-performance workstations, GPU-accelerated systems, and distributed computing clusters. Further, examples of processing tasks include 3D surface reconstruction, volume and surface area calculations, morphological analysis and fluorescence intensity quantification.

The system 200 further comprises a scanning mechanism coupled to the micro-camera array 202 and the illumination source 206. The scanning mechanism is configured to move the micro-camera array 202 and the illumination source 206 in three dimensions relative to the multi-well plate 210. In an embodiment, the scanning mechanism is configured to move the micro-camera array 202 and the illumination source 206 without disturbing the multi-well plate 210. Such a design is crucial for maintaining the integrity of the specimens and ensuring consistent imaging conditions throughout the scanning process, enabling accurate longitudinal 3D imaging at high throughput. The scanning mechanism employs precision engineering techniques to achieve smooth, vibration-free, accurate and repeatable motion of the imaging components in three dimensions (X, Y, and Z axes) while keeping the multi-well plate 210 in a stationary state. Further, key properties of the scanning mechanism include high positional accuracy, minimal mechanical coupling to the specimen stage and the ability to maintain optical alignment during movement. The stationary specimen approach offers advantages such as reduced risk of specimen perturbation, compatibility with live-cell imaging applications and the ability to perform time-lapse studies without introducing motion artifacts. Moreover, preparation of the scanning mechanism involves the use of low-vibration actuators, implementation of active vibration damping systems and careful balancing of moving components to minimize inertial effects. Additionally, types of scanning mechanisms that can achieve such an operation comprise gantry systems, stage scanners and galvanometer-based scanners. Also, examples of scanning configurations include serpentine scanning patterns, adaptive scanning based on well locations and multi-resolution scanning for targeted high-resolution imaging of specific regions. Further, examples of scanning strategies include step-and-settle imaging for high-precision capture, continuous scanning with synchronized image acquisition and adaptive scanning patterns that optimize coverage of populated wells.

In an embodiment, the processor 218 is configured to map the captured image data into per-specimen 3D measurements and generate statistical data associated with the 3D measurements. Such an advanced image processing capability transforms raw image data into quantitative metrics that characterize the morphology and properties of individual specimens within the multi-well plate 210. The mapping process involves image segmentation to identify individual specimens, 3D reconstruction techniques to create volumetric representations and feature extraction algorithms to quantify relevant parameters. Further, key properties of such a processing approach include high computational efficiency, robustness to variations in specimen appearance and the ability to handle large datasets from high-throughput imaging. The generation of per-specimen measurements and statistical data offers advantages such as automated phenotypic profiling, quantitative comparison across experimental conditions and the ability to identify subtle morphological changes. Moreover, preparation of the processing pipeline involves development of machine learning algorithms for accurate segmentation, implementation of 3D reconstruction methods such as shape-from-focus or multi-view stereo and creation of statistical analysis tools for population-level insights. Also, types of measurements that can be generated include volume, surface area, sphericity, texture parameters and spatial distribution of fluorescence signals. Additionally, examples of statistical analyses include population distributions of morphological features, correlation analyses between different parameters and automated classification of specimens based on extracted features.

In another embodiment, the processor 218 is further configured to track the per-specimen measurements longitudinally across multiple imaging sessions. Such a capability of the processor 218 enables the study of dynamic processes and temporal changes in specimen characteristics over extended periods. The tracking system employs sophisticated algorithms to match and correlate specimens across different time points, accounting for potential changes in position, orientation or appearance. Further, key properties of the longitudinal tracking approach include robust specimen identification, accurate alignment of time series data and the ability to handle missing data points or specimen divisions. The longitudinal tracking offers advantages such as the ability to study developmental processes, analysis of drug response kinetics and identification of heterogeneous behaviors within specimen populations. Also, preparation of the longitudinal tracking system involves development of feature-based or model-based tracking algorithms, implementation of data association techniques to link measurements across time points and creation of visualization tools for temporal data exploration. Moreover, types of tracking approaches include nearest-neighbor matching, probabilistic multi-hypothesis tracking and deep learning-based instance segmentation and tracking. Additionally, examples of longitudinal analyses include growth curve generation, cell lineage tracing and temporal clustering of specimen behaviors.

In yet another embodiment, the processor 218 is further configured to process the captured image data to generate one or more of volume measurements, surface area measurements, density measurements and surface granularity measurements of the specimens. Such quantitative measurements provide comprehensive characterization of specimen morphology and internal structure. The volume measurements are derived from 3D reconstructions and provide insights into overall specimen size and growth. Further, surface area measurements quantify the extent of interface of the specimen with an environment thereof, which is particularly relevant for studies of cell-cell interactions or drug absorption. Also, density measurements obtained through analysis of image intensity distributions can indicate changes in cellular composition or the presence of specific structures within the specimen. Moreover, surface granularity measurements characterize the texture and roughness of the specimen surface, which can be indicators of cellular differentiation or response to environmental factors. Additionally, key properties of such measurement techniques include high accuracy, reproducibility and the ability to handle specimens with complex morphologies. Such quantitative measurements offer advantages such as objective comparison between experimental conditions, automated phenotypic profiling and the ability to detect subtle changes that may not be apparent through solely visual inspection. Moreover, preparation of such measurement algorithms involves implementation of 3D image analysis techniques, development of surface fitting and texture analysis methods and calibration using known standards to ensure measurement accuracy. The types of analysis approaches include voxel-based volumetry, mesh-based surface area calculation, gradient-based density estimation and wavelet-based texture analysis. Further, examples of applications include quantifying organoid growth rates, assessing the impact of drugs on tissue morphology and characterizing the differentiation of stem cell populations.

In a further embodiment, the processor 218 is further configured to process the captured image data within 45 seconds for a full-plate focal stack. Such rapid processing capability is essential for high-throughput imaging applications, enabling real-time analysis and feedback during experimental workflows. The processor 218 employs optimized algorithms and parallel computing techniques to achieve such high-speed performance. Further, key properties of such rapid processing approach include efficient memory management, utilization of GPU acceleration where applicable and implementation of multi-threaded processing pipelines. The ability to process a full-plate focal stack within 45 seconds offers advantages such as immediate quality control feedback, the potential for adaptive experimental protocols based on real-time analysis and increased overall throughput of imaging experiments. Also, preparation of the high-speed processing system involves careful optimization of image processing algorithms, implementation of efficient data handling and storage strategies and utilization of high-performance computing hardware. Moreover, types of optimization techniques include algorithm parallelization, use of pre-computed look-up tables and implementation of approximate computing methods where appropriate. Additionally, examples of rapid processing applications include on-the-fly autofocus adjustment, real-time phenotype classification and dynamic adjustment of imaging parameters based on specimen characteristics.

In another embodiment, the processor 218 is further configured to process fluorescence image data to monitor calcium activity and diffusion processes of fluorescent dyes into multi-cellular bodies. Such an operation enables functional analysis of the specimens.

In a further embodiment, the processor 218 is configured to locate individual cells within the specimens, measure total fluorescence per-channel within each cell and aggregate average and total fluorescence across cells. Additionally, the processor 218 can track individual cells longitudinally to measure per-cell fluorescence brightness variations.

In still another embodiment, the processor 218 is further configured to compute one or more of minimum, mean and maximum projections of acquired fluorescence intensity data along an axial dimension. Such an operation helps reduce overall dataset sizes for effective display and downstream management.

In a further embodiment, the system 200 further comprises a user interface configured to display computed metrics and provide access to fitted surface manifolds and aligned focal stacks. The user interface allows users to visualize and analyze the 3D imaging data. The user interface is configured to display computed metrics and provide access to fitted surface manifolds and aligned focal stacks. The user interface serves as the primary means for researchers to interact with the imaging system 200, visualize results and perform in-depth analysis of acquired data. The user interface is designed to be intuitive and user-friendly, while also providing access to advanced analytical tools. Further, key properties of the user interface include responsive design for handling large datasets, customizable visualization options and integration with data export and sharing functionalities. The user interface offers advantages such as efficient data exploration, ability to correlate different measurement types and facilitation of collaborative research through shared access to processed results. Also, preparation of the user interface involves development of interactive visualization tools, implementation of data management systems for organizing and retrieving results and creation of user-friendly controls for navigating complex datasets. Additionally, types of user interface components include 3D volume renderers, heat map visualizations of quantitative metrics and time-lapse viewers for longitudinal data. Moreover, examples of user interface functionalities include interactive segmentation refinement, custom metric calculation based on user-defined regions of interest and integration with external analysis tools for specialized processing.

Optionally, the imaging array 202 may be equipped with additional sensors to capture images in different spectral ranges. The optical elements 204 may include adaptive optics components to correct for aberrations in the light path. The illumination source 206 may be a laser source for high-intensity illumination. The computer processing and control unit 214 may include additional processors for parallel processing of images. The z-axis actuator 216 may be replaced with a three-axis actuator for more flexible control over the position of the imaging array 202. The processor 218 may be replaced with a graphics processing unit (GPU) for faster image processing. The microscope system 200 may be integrated into a larger system for automated high-throughput imaging.

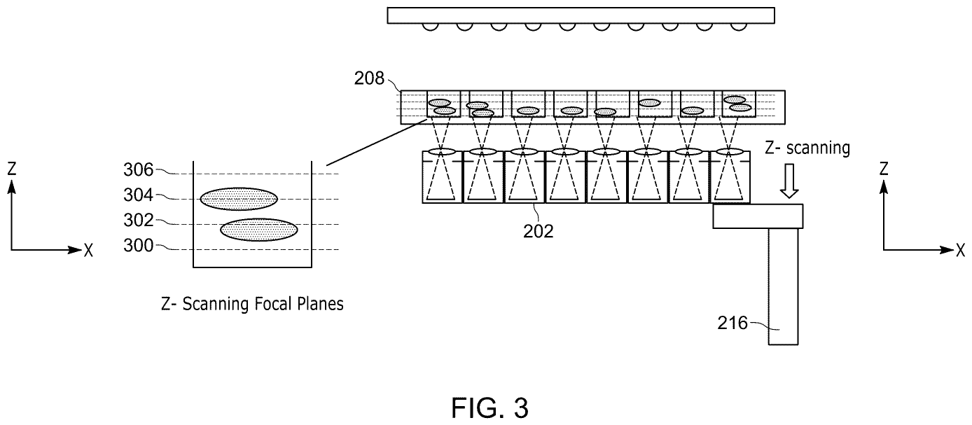

Referring to FIG. 3, there is illustrated a schematic illustration of a focal stack information acquisition method performed using the system 200 of FIG. 2, in accordance with an embodiment of the present disclosure. The method begins with the imaging array 202, which is designed to be capable of moving along the z-axis, facilitated by the z-axis actuator 216, allowing the imaging array 202 to capture images at different depths of the specimen plane 208.

The focal stack information acquisition method involves the acquisition of z-scanning focal planes 300-306. The z-scanning focal planes 300-306 are different levels or depths at which the imaging array 202 captures images. The z-scanning focal planes 300-306 include a first focal plane 300, a second focal plane 302, a third focal plane 304 and a fourth focal plane 306. Each focal plane corresponds to a different depth of the specimen, allowing the system 200 to capture a comprehensive 3D image of the specimen 212 and provide a different perspective of a structure of the specimen 212. Further, by capturing images at the different focal planes 300-306, the system 200 can create a comprehensive 3D image of the specimen 212. The number of focal planes 300-306 can be adjusted based on a size and complexity of the specimen 212.

The focal stack information acquisition method can be used in a variety of applications, including but not limited to imaging of organoids, cell cultures and other biological specimens. In an alternative embodiment, the system 200 may be used for imaging non-biological samples in fields such as materials science or geology. The system 200 may also be adapted for high-throughput imaging, allowing for rapid acquisition of 3D images of multiple specimens in a short period.

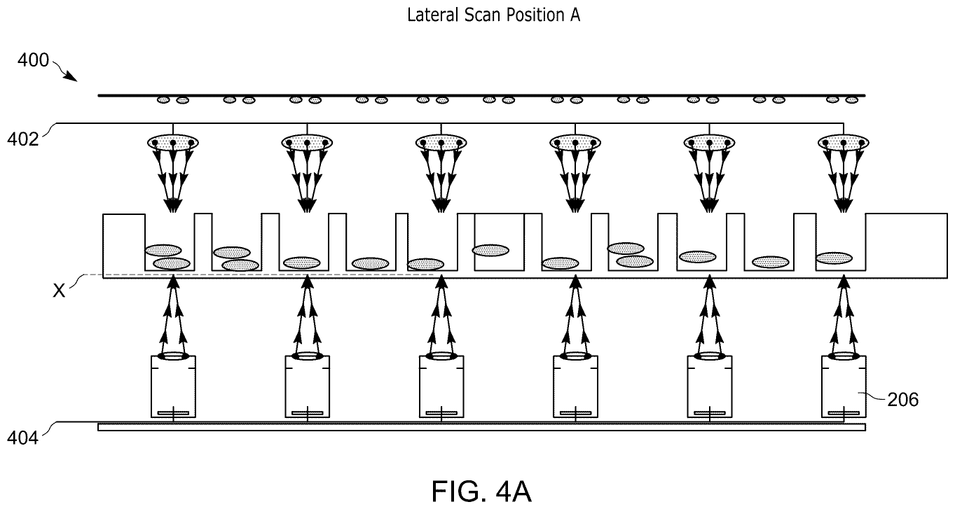

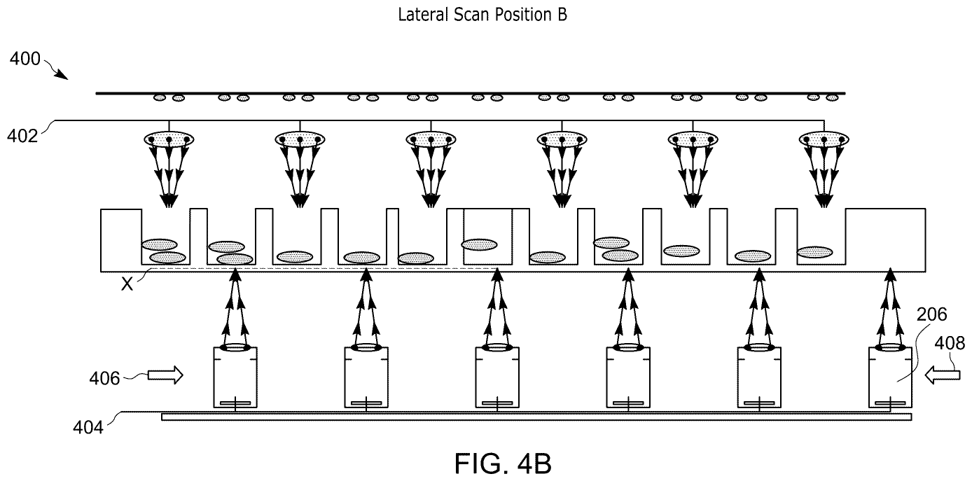

Referring to FIGS. 4A-B, there are illustrated a joint scanning apparatus 400 in two lateral positions, in accordance with embodiments of the present disclosure. The joint scanning apparatus 400 is a key component of the image processing software and is designed to map acquired whole-plate axial scan measurements into per-organoid 3D measurements and associated statistical data. The joint scanning apparatus 400 is equipped with a unique 3D array and an illumination scanning mechanism, which jointly scans the included camera array 402 to cover the entire well plate while also scanning the illumination source 206 to ensure effective imaging performance.

The camera array 402 is a critical part of the scanning technology that enables effective imaging across high-density multi-well plates. Further, unlike existing multi-camera systems for well plate imaging, the camera array 402 does not require one micro-camera per well to view all the wells. Instead, the camera array 402 utilizes the joint scanning mechanism to moves the bulky multi-camera array across the well plate in three dimensions in an optically precise manner. Such movement is achieved without disturbing the well plate itself, which is crucial for accurate longitudinal 3D imaging at high throughput.

The illumination scanning mechanism 404 is another vital component of the joint scanning apparatus 400. The illumination scanning mechanism 404 is optically optimized to deliver even specimen illumination within deep wells. Such a mechanism includes an illumination source 206 and a specialized film to maximize evenness and brightness of BF illumination and to obtain very high-speed capture in high-density plates. The illumination source 206 scans in tandem with the camera array 402, ensuring effective imaging performance across the entire well plate. The illumination scanning mechanism 404 also includes the optically optimized illumination source 206 to provide even excitation and specialized film to maximize evenness and brightness of the BF illumination and to obtain very high-speed capture in high-density plates. The joint scanning apparatus 400 is designed for 3D image acquisition, which is critical for effective imaging of most biological specimens of interest. Further, a co-designed 3D image measurement strategy and associated post-processing software is optimized to rapidly acquire accurate 3D image data across multi-well plates that can scale to high density formats.

The joint scanning apparatus 400 operates in two lateral positions, as indicated by the lateral scanning directions 406-408. Such a functionality enables the joint scanning apparatus 400 to cover a larger area of the well plate, thereby enhancing imaging capabilities thereof. The lateral scanning directions 406-408 are controlled by the software, which ensures precise movement of the camera array 402 and the illumination scanning mechanism 404.

In an embodiment, the joint scanning apparatus 400 may be equipped with a larger camera array for imaging even higher-density multi-well plates. Similarly, the illumination scanning mechanism 404 may include multiple illumination arrays for more effective illumination of deep wells. The lateral scanning direction 406-408 may also be adjustable, allowing for more flexible operation of the joint scanning apparatus.

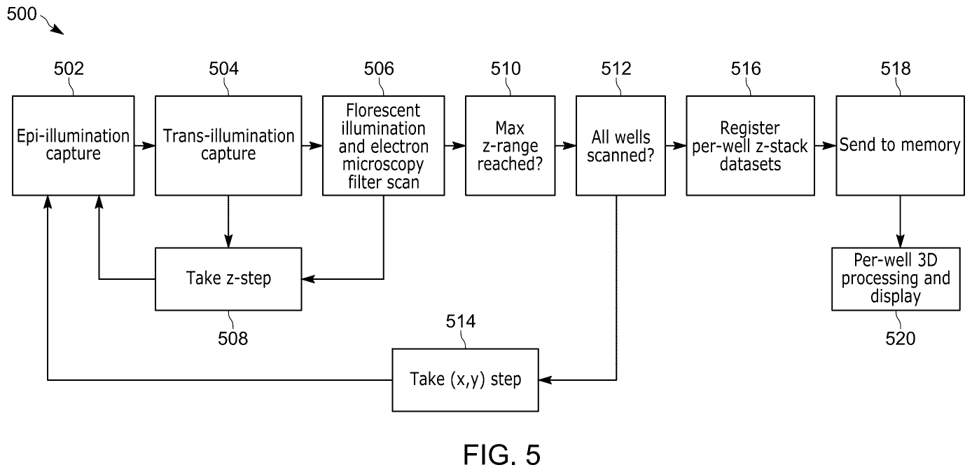

Referring to FIG. 5, there is illustrated a workflow 500 for image processing and analysis, in accordance with an embodiment of the present disclosure. The workflow 500 begins with the acquisition of whole-plate axial scan measurements, represented by numerals 502-514. The measurements are obtained using an image acquisition device (not shown), which can be any suitable device capable of capturing high-resolution images of the whole plate. The acquired measurements are then mapped into per-organoid 3D measurements and associated statistical data, as represented by numerals 516-518.

Such a mapping process is carried out by an image processing software designed to detect and crop brain organoids per-well. Such detection and cropping are achieved by refining the software to locate individual organoids of various sizes and ensure that all organoids per well plate per focal stack are accurately identified and cropped. The software utilizes a feature detection pipeline and assumes one organoid per well.

Thereafter, a modified version of shape-from-focus (SFF) is applied to approximate a per-organoid depth map. The SFF takes a focal stack of images as input and is applied in parallel across all well plate data. The depth estimation process of the SFF is based on the comparison of image gradients at different scales and provides depth estimates of the organoid surface. Such estimates are used to initialize a novel parametric model.

The parametric model iteratively refines a full 3D surface profile estimate for each organoid, as represented by numeral 520. Such a process is represented by a 2D manifold defining the 3D outer boundary of the organoid, with the aim of minimizing the difference between forward-model-simulated image intensities and ground-truth captured data. The parametric model assumes fully incoherent illumination and applies a depth-dependent convolution and scaling before merging data across all axial planes to form each simulated focal stack measurement.

The organoid manifold is perturbed to minimize the difference between simulated and ground-truth measurements. Further, to ensure model accuracy, standard volume/surface area measurements of 100 unique organoids of various size and shape are obtained in vitro for checkpoint assessment. The model output includes the final organoid surface manifold as well as key statistical data including volume, surface area, average density and surface granularity. The workflow 500 enables to fully process a full-plate focal stack within 45 seconds.

Additionally, a user interface is developed to display saved and tracked computed metrics across imaging experiments and to provide access to fitted surface manifolds and aligned focal stacks for viewing and analysis. Moreover, longitudinal tracking of each organoid is achieved via a per-plate unique identifier (ID) and automatic detection of each well location.

In an embodiment, the workflow 500 also includes processing of acquired fluorescence image data at high speeds for video-type assays. Such an operation includes monitoring calcium activity and diffusion processes of various fluorescent dyes into multi-cellular bodies. The image processing software can additionally process longitudinally acquired 3D well plate scans of cell migration, apoptosis, death, interaction and the like. In another embodiment, fluorescent image analysis software can be used to locate individual cells, measure total fluorescence per-channel within each cell and aggregate the average and total fluorescence across cells for experimental insight.

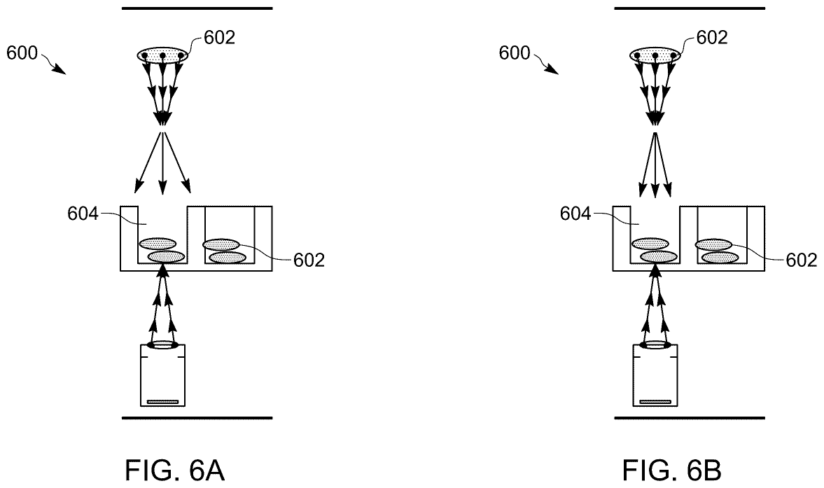

Referring to FIGS. 6A-B, there are illustrated different stages of an illumination and scanning method, in accordance with an embodiment of the present disclosure. The figures represent an image processing software system designed to map acquired whole-plate axial scan measurements into per-organoid 3D measurements and associated statistical data.

In an initial stage 600, the software system is designed to detect and crop brain organoids 602 per-well 604. The software system utilizes a feature detection pipeline to identify and isolate the organoids 602 in each well 604. The pipeline is designed to operate under the assumption that there is one organoid 602 per well 604, which is a common setup for 96 or 384 well plates. Such an assumption can be adjusted to accommodate different setups.

The software system is then programmed to refine detection and cropping capabilities thereof using fixed organoids of various sizes. The aim is to ensure that the software system can locate and crop all organoids 602 per well plate per focal stack with a normalized accuracy of over 99.5%. Further, to achieve such accuracy, the software applies a modified version of SFF to approximate a per-organoid depth map. The SFF takes a focal stack of images as input and applies the focal stack in parallel across all well plate data.

The next stage 606 involves the application of a parametric model designed to iteratively refine a full 3D surface profile estimate for each organoid 602. The model assumes fully incoherent illumination and applies a depth-dependent convolution and scaling before merging data across all axial planes to form each simulated focal stack measurement. The organoid manifold is then perturbed to minimize the difference between simulated and ground-truth measurements.

The output from the model includes the final organoid surface manifold as well as key statistical data such as volume, surface area, average density and surface granularity. The software aims to fully process a full-plate focal stack within 45 seconds. In addition, the software system includes a user interface to display saved and tracked computed metrics across imaging experiments, providing access to fitted surface manifolds and aligned focal stacks for viewing and analysis.

The software system also includes additional capabilities for processing acquired fluorescence image data at high speeds for video-type assays. Such capabilities include monitoring calcium activity and diffusion processes of various fluorescent dyes into multi-cellular bodies. The software system can also process longitudinally acquired 3D well plate scans of cell migration, apoptosis, death, interaction and other cellular activities.

In one embodiment, the fluorescent image analysis software system can be used to locate individual cells, measure total fluorescence per-channel within each cell and aggregate the average and total fluorescence across cells for experimental insight. In an embodiment, the software system can also track individual cells longitudinally to measure per-cell fluorescence brightness variations. Further, minimum, mean and/or maximum projections of acquired fluorescence intensity data may be computed along the axial dimension of acquired 3D scans to reduce overall dataset sizes for effective display and downstream management. Also, fluorescent image data and associated statistical data may be aggregated with bright-field data acquire and its associated statistical data to maximize insight into multi-cellular specimens.

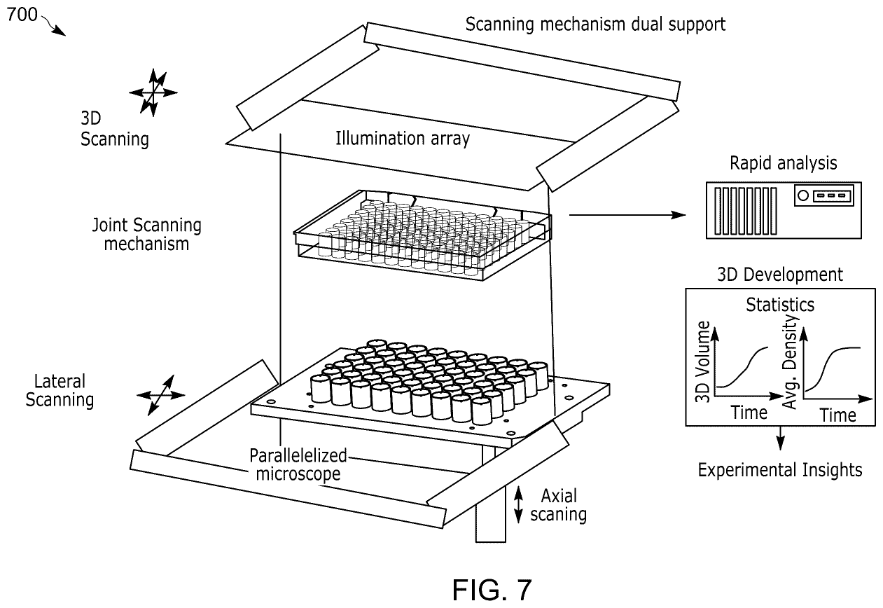

Referring to FIG. 7, there is illustrated an exploded view of the overall architecture of a system 700 (such as the system 200 of FIG. 2) with 3D scanning and analysis capabilities, in accordance with an embodiment of the present disclosure. The system 700 is primarily designed for 3D image acquisition, which is highly important for effective imaging of various biological specimens. The system 700 includes an image processing software, a user interface and a Python software library with a graphical user interface (GUI) front-end for microscope control, image/video acquisition and automated well identification and extraction.

The image processing software is responsible for mapping acquired whole-plate axial scan measurements into per-organoid 3D measurements and associated statistical data. The software is also designed to detect and crop brain organoids per-well. The software employs a common feature detection pipeline and assumes one organoid per well. The software is also capable of applying a modified version of SFF to approximate a per-organoid depth map. The SFF takes a focal stack of images as input and applies the focal stack in parallel across all well plate data. The software further includes a parametric model designed to iteratively refine a full 3D surface profile estimate for each organoid, aiming to minimize the difference between forward-model-simulated image intensities and ground-truth captured data.

The user interface is designed to longitudinally track measurements per-organoid across the development cycle. The user interface provides access to fitted surface manifolds and aligned focal stacks for viewing and analysis. The user interface also allows for the display of saved and tracked computed metrics across imaging experiments.

The Python software library with a GUI front-end for microscope control, image/video acquisition and automated well identification and extraction, is another integral part of the system. The Python software library is designed to control the microscope, acquire images/videos and identify and extract wells automatically. The Python software library is also capable of processing acquired fluorescence image data at high speeds for video-type assays, including monitoring calcium activity and diffusion processes of various fluorescent dyes into multi-cellular bodies.

In an embodiment, the system can also process longitudinally acquired 3D well plate scans of cell migration, apoptosis, death, interaction and the like. The software can also be used to locate individual cells, measure total fluorescence per-channel within each cell and aggregate the average and total fluorescence across cells for experimental insight. The software can also track individual cells longitudinally to measure per-cell fluorescence brightness variations.

In another embodiment, the system is designed for array scanning. The system includes a novel 3D array and illumination scanning mechanism, which jointly scans the included camera array to cover the entire well plate, while also scanning the illumination to ensure effective imaging performance. The system also includes an optically optimized illumination source to provide even excitation and specialized film to maximize evenness and brightness of BF illumination and to obtain very high-speed capture in high-density plates. The system is also optimized to generate accurate key metrics of multicellular systems. The combination of the aforesaid features leads to the joint scanning mechanism that is coupled to both an array of micro-cameras and an illumination array. The joint scanning mechanism is able to move the bulky multi-camera array and illumination source across the well plate in three dimensions in an optically precise manner without disturbing the well plate itself, which is critical for accurate longitudinal 3D imaging at high throughput. The joint scanning mechanism that is coupled to both an array of micro-cameras and an illumination array is tailored for use in a parallelized microscope for rapid imaging and analysis of many specimens.

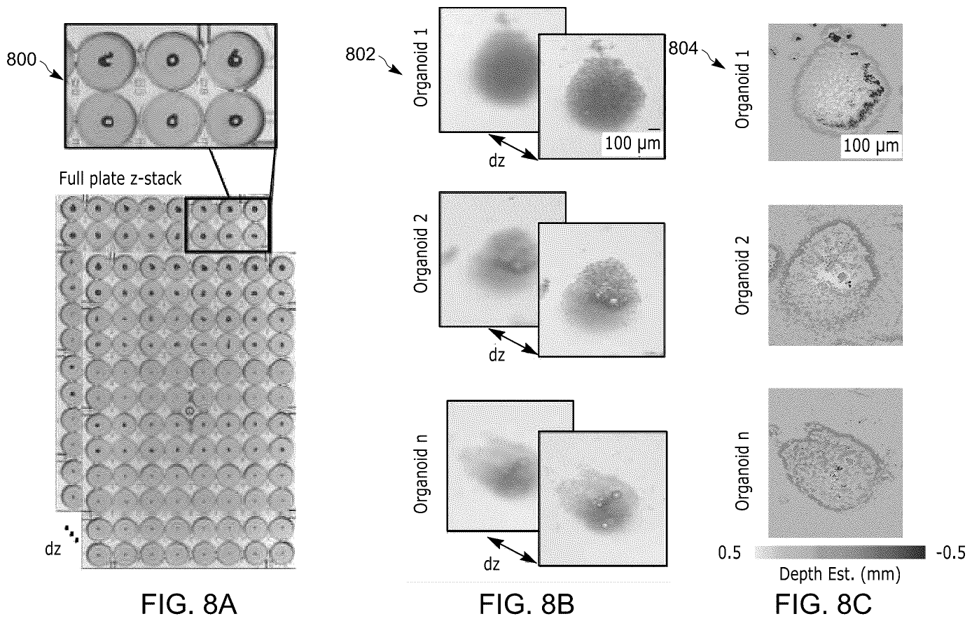

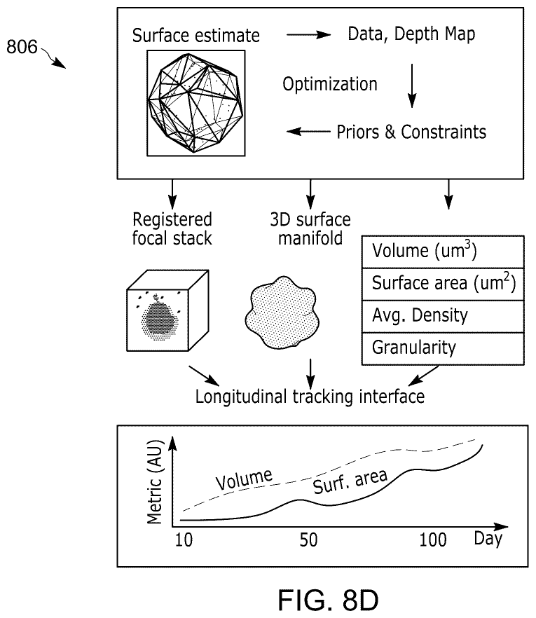

Referring to FIGS. 8A-D, there is illustrated an exemplary image processing pipeline for organoid detection and analysis, in accordance with an embodiment of the present disclosure. The pipeline 800 begins with the acquisition of whole-plate axial scan measurements 800 shown in FIG. 8A. The measurements are obtained using the image acquisition module, which is designed to capture high-resolution images of the entire well plate. The acquired images are then mapped into per-organoid 3D measurements and associated statistical data 802 shown in FIG. 8B, using the image mapping module. The module uses advanced image processing algorithms to convert the 2D images into 3D representations of each organoid.

The next step 804 in the pipeline involves the use of a detection and cropping module shown in FIG. 8C. The detection and cropping module is designed to locate and crop brain organoids per well. The detection and cropping module employs a refined software that can detect and crop all organoids per well plate per focal stack with a high degree of accuracy. The organoids are then subjected to a SFF method, implemented by the depth map approximation module. The SFF method takes a focal stack of images as input and generates an approximate outline of the front-facing organoid surface.

Following the depth map approximation, a parametric model initialization module is used to initialize a novel parametric model 806, shown in FIG. 8D. The model is used to refine a full 3D surface profile estimate for each organoid. The parametric model assumes fully incoherent illumination and applies a depth-dependent convolution and scaling before merging data across all axial planes to form each simulated focal stack measurement.

The pipeline also includes a model refinement module, which perturbs the organoid manifold to minimize the difference between simulated and ground-truth measurements. The model refinement module ensures the accuracy of the model by obtaining standard volume/surface area measurements of unique organoids of various sizes and shapes in vitro. The final output of the pipeline includes the organoid surface manifold and key statistical data including volume, surface area, average density and surface granularity. Such parameters are generated by the statistical data generation module. The pipeline is designed to fully process a full-plate focal stack within a specified time frame.

In addition to the aforementioned modules, the pipeline also includes a user interface module. The user interface module is designed to display saved and tracked computed metrics across imaging experiments and to provide access to fitted surface manifolds and aligned focal stacks for viewing and analysis. The pipeline also includes a longitudinal tracking module. The longitudinal tracking module is designed to track each organoid over time. Such tracking is achieved via a per-plate unique ID and automatic detection of each well location, which assumes one unique organoid per well.

In a preferred embodiment, the pipeline can also process acquired fluorescence image data at high speeds for video-type assays. Such an operation is performed using a fluorescence image analysis module, which can locate individual cells, measure total fluorescence per-channel within each cell and aggregate the average and total fluorescence across cells for experimental insight.

The pipeline 800 provides a comprehensive solution for organoid detection and analysis. The pipeline 800 combines multiple modules and methods to generate accurate 3D representations and statistical data of organoids, enabling detailed analysis and tracking of organoid development over time.

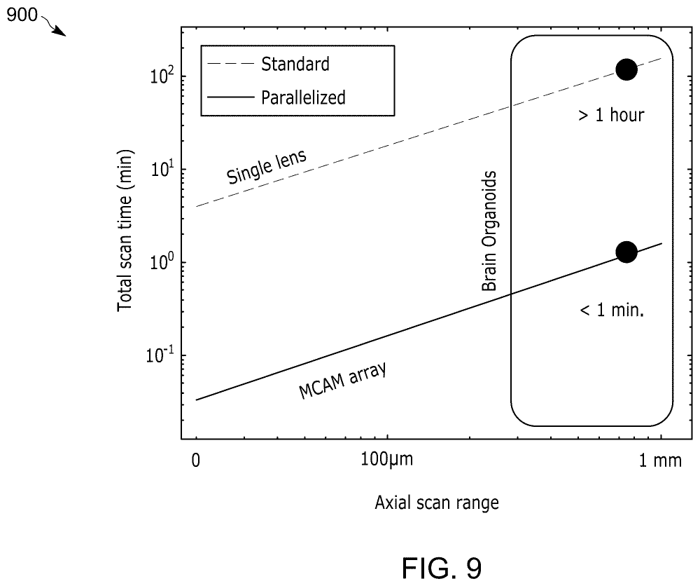

Referring to FIG. 9, there is illustrated a method 900 for parametric modeling and longitudinal tracking of 3D organoid surface, in accordance with an embodiment of the present disclosure. The method 900 begins with the acquisition of whole-plate axial scan measurements. The image processing software maps such measurements into per-organoid 3D measurements and associated statistical data. The software is designed to work with organoids of various sizes and is capable of locating and cropping all organoids per well plate per focal stack with a high degree of accuracy.

The software applies a modified version of SFF to approximate a per-organoid depth map. The SFF takes a focal stack of images as input and is applied in parallel across all well plate data. Further, preliminary tests of the SFF method provide an approximate outline of the front-facing organoid surface. The depth estimation process of the SFF is based upon comparison of image gradients at different scales and provides depth estimates of the organoid surface that are used to initialize a novel parametric model.

The parametric model iteratively refines a full 3D surface profile estimate for each organoid. The 3D surface profile is a 2D manifold defining 3D outer boundary of the organoid. The aim of the parametric model is to minimize the difference between forward-model-simulated image intensities and ground-truth captured data. The model assumes fully incoherent illumination and applies a depth-dependent convolution and scaling before merging data across all axial planes to form each simulated focal stack measurement. The organoid manifold is perturbed to minimize the difference between simulated and ground-truth measurements.

Moreover, to ensure model accuracy, standard volume/surface area measurements of 100 unique organoids of various size and shape in vitro are obtained for checkpoint assessment. The output of the model includes the final organoid surface manifold as well as key statistical data including volume, surface area, average density and surface granularity. Also, a user interface displays saved and tracked computed metrics across imaging experiments and provides access to fitted surface manifolds and aligned focal stacks for viewing and analysis. Further, longitudinal tracking of each organoid is first achieved via a per-plate unique ID and automatic detection of each well location.

Moreover, additional software can process acquired fluorescence image data at high speeds for video-type assays, including monitoring calcium activity and diffusion processes of various fluorescent dyes into multi-cellular bodies. The software can also process longitudinally acquired 3D well plate scans of cell migration, apoptosis, death, interaction and the like. In one embodiment, fluorescent image analysis software can be used to locate individual cells, measure total fluorescence per-channel within each cell and aggregate the average and total fluorescence across cells for experimental insight. The software can also track individual cells longitudinally to measure per-cell fluorescence brightness variations. The system is designed to fully process a full-plate focal stack within 45 seconds. Such speed and efficiency make the system ideal for use in high-throughput experiments and studies.

Further disclosed is a method (also referred to as “parallelized scanning method”) for imaging multi-well plates. The method comprises positioning a micro-camera array and an illumination source relative to a multi-well plate using a scanning mechanism, activating the illumination source to illuminate wells of the multi-well plate, capturing image data of the illuminated wells using the micro-camera array, processing the captured image data to generate three-dimensional measurements of specimens within the wells and moving the micro-camera array and the illumination source in three dimensions relative to the multi-well plate using the scanning mechanism to image multiple wells.

In an embodiment, the method further comprises mapping the captured image data into per-specimen three-dimensional measurements and generating statistical data associated with the three-dimensional measurements. Such an operation allows for quantitative analysis of the specimens.

In another embodiment, the method further comprises tracking the per-specimen measurements longitudinally across multiple imaging sessions. Such an operation enables monitoring of changes in specimen characteristics over time.

In yet another embodiment, the processing further comprises processing the captured image data to generate one or more of volume measurements, surface area measurements, density measurements and surface granularity measurements of the specimens.

In still another embodiment, the processing further comprises processing fluorescence image data to monitor calcium activity and diffusion processes of fluorescent dyes into multi-cellular bodies; and further comprising the steps of locating individual cells within the specimens, measuring total fluorescence per-channel within each cell and aggregating average and total fluorescence across cells. Such an operation allows for detailed functional analysis of the specimens at both the cellular and multicellular levels.

The parallelized scanning method is an integral part of the 3D array and illumination scanning mechanism, allowing for efficient and effective imaging across high-density multi-well plates, such as those with 384, 1536, 6144 or other large numbers of wells. The scanning mechanism is designed to move the included camera array and illumination source across the well plate in three dimensions without disturbing the well plate itself, a critical aspect for accurate longitudinal 3D imaging at high throughput.

The parallelized scanning method is designed to work in conjunction with the optically optimized illumination array. The array provides even specimen illumination within deep wells, a critical requirement for next-generation multicellular specimen development and high-throughput study. The illumination array includes optimized optical elements and a PDLC sheet to ensure even specimen illumination across all wells for both bright-field and fluorescent capture.

### Applications and Alternatives

The system is associated with a capability for 3D image acquisition using a co-designed 3D image measurement strategy and associated post-processing software that is optimized to rapidly acquire accurate 3D image data across multi-well plates that can scale to high-density formats. The system is also optimized to generate accurate key metrics such as surface area, volume, morphological features and fluorescent bioactivity of multicellular systems.

Further, one or more micro-cameras within the array capture a set of one or more epi-illumination images of a particular well by turning on different epi-illumination sources. Moreover, a set of one or more trans-illumination images are then captured of the same well by turning on different trans-illumination sources. Such multi-illumination capture is repeated at one or more axial locations of the micro-camera array (MCAM), with the micro-cameras focused at one or more z-slices within the specimen. Thus, the parallelized scanning method is associated with for high-speed and high-accuracy 3D imaging across high-density multi-well plates.

For fluorescence imaging applications, the system can process the data to monitor dynamic processes like calcium signaling and diffusion of fluorescent dyes. Further, individual cells can be located within multi-cellular specimens, with per-cell fluorescence measurements aggregated to provide insights into overall specimen behavior. The software supports tracking of individual cells over time to quantify variations in fluorescence.

In an embodiment, the micro-camera array may utilize a combination of different sensor types optimized for various imaging modalities. For example, high-sensitivity sCMOS sensors may be used for low-light fluorescence imaging, while high-resolution CMOS sensors capture detailed brightfield images. Such multi-modal approach would allow simultaneous acquisition of complementary datasets.

In another embodiment, the system is incorporated with adaptive optics elements in the optical path of each micro-camera. Such as elements, including deformable mirrors or spatial light modulators, may dynamically correct for aberrations introduced by the specimen or imaging system. Such incorporation would enable diffraction-limited imaging even deep within thick specimens like organoids.

Optionally, the illumination source may be enhanced with structured illumination capabilities. The projection of patterned light onto specimens and computationally processing the resulting images enables super-resolution information beyond the diffraction limit may be extracted. Such an operation would enable nanoscale structural analysis of subcellular features across large numbers of specimens in parallel.

Optionally, the software may be expanded to incorporate machine learning algorithms for automated phenotypic analysis. For example, convolutional neural networks may be trained on large datasets of organoid images to automatically classify specimens based on morphological features or detect subtle developmental abnormalities. Such an incorporation would greatly accelerate large-scale screening applications.

For long-term live imaging experiments, the entire system may be integrated into an environmental control chamber. Moreover, precise regulation of temperature, humidity and gas composition would maintain optimal culture conditions during extended imaging sessions. Also, microfluidic perfusion may allow automated media exchange and compound addition without disturbing specimens.

The disclosed system captures comprehensive 3D data across entire specimens, allowing for more holistic analysis of complex biological structures like organoids. Further, while conventional techniques have employed a Fourier ptychographic approach to provide high resolution, such a technique requires sequential illumination at multiple angles. In contrast, the parallel micro-camera array of the present disclosure enables simultaneous multi-view imaging, substantially increasing throughput for large-scale studies. The optimized illumination source also provides more uniform sample illumination compared to the angled illumination of ptychography.

Moreover, other conventional techniques have used a four-dimensional hypercube for efficient data management. However, an ability of the current system to directly generate 3D measurements and statistical data from raw image data, rather than just improved 2D images, provides more immediately useful information for biological research applications.

The disclosed system finds broad applications across many areas of biological and biomedical research. For example, in drug discovery, the system can be used for high-throughput screening of compound libraries against 3D cell culture models like organoids or spheroids. The ability to rapidly quantify changes in organoid morphology and function allows efficient identification of hit compounds. In another example, in the field of regenerative medicine, the system enables detailed monitoring of stem cell differentiation and tissue formation processes. In such an example, researchers can track the development of complex multicellular structures over time, providing insights into morphogenesis and tissue engineering strategies. The non-destructive nature of the imaging allows longitudinal studies on the same specimens. In still another example, for cancer research, the system facilitates large-scale analysis of tumor spheroids or patient-derived organoids. In such an example, drug responses, invasion processes and heterogeneity within tumor models can be quantitatively assessed. The fluorescence capabilities allow monitoring of specific molecular pathways or cell populations within these 3D cultures. In a further example, in developmental biology, the system can be applied to study embryoid bodies, gastruloids or other in vitro models of early development. The high-throughput 3D imaging capabilities enable screening for factors that influence morphogenesis and patterning. Further, subtle phenotypes that may be missed by conventional 2D imaging can be detected and quantified.

The technology is also valuable for toxicology studies, allowing rapid assessment of compound effects on complex 3D tissue models. It will be appreciated that researchers can evaluate cytotoxicity, developmental toxicity or organ-specific toxicity using relevant organoid systems. The ability to perform repeated, non-destructive measurements enables detection of both acute and chronic effects.

Further, in the field of infectious disease research, the system can be used to study host-pathogen interactions in 3D tissue models. It will be appreciated that researchers can monitor the spread of infections through organoids or spheroids, quantify tissue damage and evaluate the efficacy of antimicrobial treatments. The fluorescence capabilities allow tracking of labeled pathogens or host response markers.

Moreover, for neuroscience applications, the system enables high-throughput analysis of brain organoids or 3D neuronal cultures. It will be appreciated that researchers can quantify neurite outgrowth, synapse formation and network activity in response to various stimuli or genetic manipulations. The ability of the system to capture calcium imaging data is particularly valuable for functional studies of neural circuits.

Also, in the area of metabolic disease research, the technology can be applied to study 3D models of liver, pancreas or adipose tissue. In such an example, researchers can assess lipid accumulation, insulin secretion or other metabolic parameters across large numbers of organoids or spheroids. The system enables efficient screening of therapeutic compounds or genetic factors that influence metabolic function.

The system also has potential applications in plant science, allowing high-throughput phenotyping of plant tissue cultures or seedlings grown in multi-well formats. In such an example, researchers can quantify root development, shoot morphology or cellular responses to various environmental conditions or genetic modifications.

Further, for immunology research, the system facilitates analysis of 3D lymphoid organoids or immune cell aggregates. In such an example, researchers can study immune cell migration, interactions and activation in more physiologically relevant contexts compared to traditional 2D cultures. The ability of the system to track individual cells over time is particularly valuable for studying dynamic immune processes.

The high-throughput capabilities of the system substantially increase the scale and speed of 3D biological imaging experiments, enabling studies that were previously impractical or impossible. The non-destructive nature of the imaging allows true longitudinal tracking of specimen development, providing insights into dynamic biological processes.

Also, an ability of the system to generate quantitative 3D measurements and statistical data provides researchers with rich datasets for in-depth analysis. Such an ability exceeds qualitative observations to enable robust, reproducible phenotypic characterization. The multi-modal imaging capabilities, combining brightfield and fluorescence, offer complementary information about specimen structure and function.

Additionally, by enabling large-scale analysis of 3D cell culture models such as organoids, the system bridges a gap between traditional 2D cell culture and animal models. Such a capability of the system has the potential to reduce animal use in research while providing more physiologically relevant data. The high-throughput nature of the system also accelerates the drug discovery and development process.

The flexibility and scalability of the system make the system adaptable to a wide range of biological specimens and experimental designs. Further, from single cells to complex organoids, from short-term assays to long-term developmental studies, the system can be optimized for diverse research needs. Such versatility maximizes potential impact of the system across multiple fields of life science research.

### General Definitions

It will be appreciated that various aspects of the disclosure may be embodied as a method, system, computer readable medium, and/or computer program product. Aspects of the disclosure may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the disclosure may take the form of a computer program product on a computer-usable storage medium having computer-usable program code embodied in the medium.

Any suitable computer useable medium may be utilized for software aspects of the disclosure. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific embodiments (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium may even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the disclosure may be written in an object-oriented programming language such as Java, Smalltalk, C++ or the like. However, the program code for carrying out operations of the disclosure may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The disclosure may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network includes wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The disclosure may be applied to any wireless/wireline communications network, regardless of physical componentry, physical configuration, or communications standard(s).

In some aspects, wireless communication interfaces may include, but are not limited to, an Intranet connection, Internet, Personal Area Networks (PANs) for the exchange of data over short distances, e.g., using short-wavelength radio transmissions in the industrial, scientific, and medical (ISM) band ISM band from 2400-2480 MHz) from fixed and mobile devices (e.g., Bluetooth® technology), wireless fidelity (Wi-Fi), Wi-Max, IEEE 802.11 technology, radio frequency (RF), Infrared Data Association (IrDA) compatible protocols, Local Area Networks (LANs), Wide Area Networks (WANs), Shared Wireless Access Protocol (SWAP), Zigbee, Near-Field Communication (NFC), LiFi, 5G, any combinations thereof, and other types of wireless networking protocols.

Certain aspects of disclosure are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the disclosure.

Any of a variety of light sources may be used to provide the excitation and/or imaging light, including but not limited to, tungsten lamps, tungsten-halogen lamps, arc lamps, lasers, light emitting diodes (LEDs), or laser diodes.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present disclosure. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the disclosure. However, the disclosure should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the disclosure as defined by the following claims.

1. A system for imaging multi-well plates, comprising:
a) a micro-camera array comprising a plurality of micro-cameras;
b) an illumination array configured to provide illumination to wells of a multi well plate;
c) a scanning mechanism coupled to the micro-camera array and the illumination array, the scanning mechanism configured to move the micro-camera array and the illumination array in three dimensions relative to the multi-well plate;
d) a controller configured to:
i) control the scanning mechanism to position the micro-camera array and the illumination array relative to the multi-well plate;
ii) activate the illumination array to illuminate wells of the multi-well plate; and
iii) control the micro-camera array to capture image data of the illuminated wells; and
e) a processor configured to process the captured image data to generate three-dimensional measurements of specimens within the wells.

2. The system of claim 1, wherein the illumination array comprises a plurality of light sources arranged to provide even illumination across the wells of the multi-well plate.

3. The system of claim 2, wherein the illumination array further comprises one or more optical elements configured to optimize the illumination provided by the light sources.

4. The system of claim 1, further comprising a polymer-dispersed liquid crystal (PDLC) sheet configured to enhance evenness and brightness of illumination.

5. The system of claim 1, wherein the illumination array is configured to provide both bright-field and fluorescent illumination.

6. The system of claim 1, wherein the scanning mechanism is configured to move the micro-camera array and the illumination array without disturbing the multi-well plate.

7. The system of claim 1, wherein the processor is further configured to:
map the captured image data into per-specimen three-dimensional measurements; and
generate statistics associated with the three-dimensional measurements.

8. The system of claim 7, wherein the processor is further configured to track the per-specimen measurements longitudinally across multiple imaging sessions.

9. The system of claim 1, wherein the processor is configured to process the captured image data to generate one or more of: volume measurements, surface area measurements, density measurements, and surface granularity measurements of the specimens.

10. The system of claim 1, wherein the processor is configured to process the captured image data within 45 seconds for a full-plate focal stack.

11. The system of claim 1, further comprising a user interface configured to display computed metrics and provide access to fitted surface manifolds and aligned focal stacks.

12. The system of claim 1, wherein the processor is further configured to process fluorescence image data to monitor calcium activity and diffusion processes of fluorescent dyes into multi-cellular bodies.

13. The system of claim 1, wherein the processor is further configured to:
ei) locate individual cells within the specimens;
eii) measure total fluorescence per-channel within each cell; and
eiii) aggregate average and total fluorescence across cells.

14. The system of claim 13, wherein the processor is further configured to track individual cells longitudinally to measure per-cell fluorescence brightness variations.

15. The system of claim 1, wherein the processor is further configured to compute one or more of minimum, mean, and maximum projections of acquired fluorescence intensity data along an axial dimension.

16. A method for imaging multi-well plates, comprising:
a) positioning a micro-camera array and an illumination array relative to a multi-well plate using a scanning mechanism;
b) activating the illumination array to illuminate wells of the multi-well plate;
c) capturing image data of the illuminated wells using the micro-camera array;
d) processing the captured image data to generate three-dimensional measurements of specimens within the wells; and
e) moving the micro-camera array and the illumination array in three dimensions relative to the multi-well plate using the scanning mechanism to image multiple wells.

17. The method of claim 16, further comprising:
f) mapping the captured image data into per-specimen three-dimensional measurements; and
g) generating statistics associated with the three-dimensional measurements.

18. The method of claim 17, further comprising:
h) tracking the per-specimen three-dimensional measurements longitudinally across multiple imaging sessions.

19. The method of claim 16, wherein step (d) further comprises processing the captured image data to generate one or more of: volume measurements, surface area measurements, density measurements, and surface granularity measurements of the specimens.

20. The method of claim 16, wherein step (d) further comprises processing fluorescence image data to monitor calcium activity and diffusion processes of fluorescent dyes into multi-cellular bodies; and further comprising:
f) locating individual cells within the specimens;
g) measuring total fluorescence per-channel within each cell; and
h) aggregating average and total fluorescence across cells.
